(19) United States
(12) Patent Application Publication
(10) Pub. No.: US 2012/0287781 A1
(43) Pub. Date: Nov. 15, 2012

(54) MOBILE VIRTUAL NETWORK OPERATOR MEDIATOR

(75) Inventor: Arturo Maria, Bellevue, WA (US)

(73) Assignee: AT&T MOBILITY II LLC, Atlanta, GA (US)

(21) Appl. No.: 13/105,846

(22) Filed: May 11, 2011

(51) Int. Cl. H04L 12/26; H04L 12/56

(52) U.S. Cl. 370/229; 370/401

(57) ABSTRACT

The disclosed subject matter provides centralized carrier-side moderation for mobile virtual network operator support. The traffic stream received by a carrier from a radio area network can include carrier traffic, mobile virtual network operator traffic, or combinations thereof. Inspection of the traffic stream can allow the mobile virtual network operator traffic to be dynamically redirected to a mobile virtual network operator gateway. Redirection of traffic can be based on rules that can be provisioned by the carrier or the mobile virtual network operator. Further, the core-components of the mobile virtual network operator can be virtualized on the carrier-side to support deployment of a mobile virtual network operator.

### TECHNICAL FIELD

The disclosed subject matter relates to carrier network support of mobile virtual network operator(s) and, more particularly, to responding to mediation of mobile virtual network operator service(s) from within a carrier network.

### BACKGROUND

Conventional telecommunications carrier network support of a mobile virtual network operator (MVNO) is generally resource intensive, often including human support expense, capitol investment costs, and network overhead associated with routing data traffic from a telecommunications carrier radio area network (RAN) to a core-network component of the MVNO. Further, the economics of supporting MVNOs, especially in the United States, has favored exclusion of MVNOs from large telecommunications carrier resources. This exclusivity is often associated with the extreme capitol investments related to deploying a RAN and a desire to control the RAN as a resource of the carrier in order to effectively recoup the sizeable investment.

However, where unused capacity exists on a carrier network, consumption of this unused capacity becomes more desirable. In some instances, MVNOs can attract a customer base that may not be otherwise well represented with a carrier having excess capacity. As such, it can be desirable to sell the excess capacity to the MVNO for use by MVNO subscribers. Where the desire to support MVNOs exists, support for MVNO service by a carrier can facilitate effective deployment of one or more MVNOs.

The above-described deficiencies of conventional carrier support for MVNOs are merely intended to provide an overview of some of problems of current technology, and are not intended to be exhaustive. Other problems with the state of the art, and corresponding benefits of some of the various non-limiting embodiments described herein, may become further apparent upon review of the following detailed description.

### SUMMARY

The following presents a simplified summary of the disclosed subject matter in order to provide a basic understanding of some aspects of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In contrast to conventional support of an MVNO, which can include large investments in manpower, capitol equipment, and network overhead, telecommunications carrier core-network support of a mediator for MVNOs can provide automatic provisioning and support of one or more MVNOs. Further, incorporation of virtualized core-network components can reduce the capitol investment needed for an MVNO to deploy. Moreover, security can be addressed in a tightly controlled carrier environment and be deployed to one or more subscriber MVNOs in an automated manner.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages and novel features of the disclosed subject matter will become apparent from the following detailed description when considered in conjunction with the drawings.

### BRIEF DESCRIPTION OF DRAWINGS

FIG. 1 is an illustration of a system that facilitates mediation of a mobile virtual network operator in accordance with aspects of the subject disclosure.

FIG. 2 is a depiction of a system that facilitates mediation of a mobile virtual network operator in accordance with aspects of the subject disclosure.

FIG. 3 illustrates a system that facilitates mediation of a mobile virtual network operator in accordance with the disclosed subject matter.

FIG. 4 is a depiction of a system that facilitates mediation of a mobile virtual network operator and can provide virtualized core-network components in accordance with aspects of the subject disclosure.

FIG. 5 illustrates a method facilitating mediation of a mobile virtual network operator with aspects of the subject disclosure.

FIG. 6 illustrates a method facilitating mediation of a mobile virtual network operator in accordance with aspects of the subject disclosure.

FIG. 7 illustrates a method for facilitating mediation of a mobile virtual network operator in accordance with aspects of the subject disclosure.

FIG. 8 illustrates a block diagram of an exemplary embodiment of an access point to implement and exploit one or more features or aspects of the subject disclosure.

FIG. 9 is a block diagram of an exemplary embodiment of a mobile network platform to implement and exploit various features or aspects of the subject disclosure.

FIG. 10 illustrates a block diagram of a computing system operable to execute the disclosed systems and methods in accordance with an embodiment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

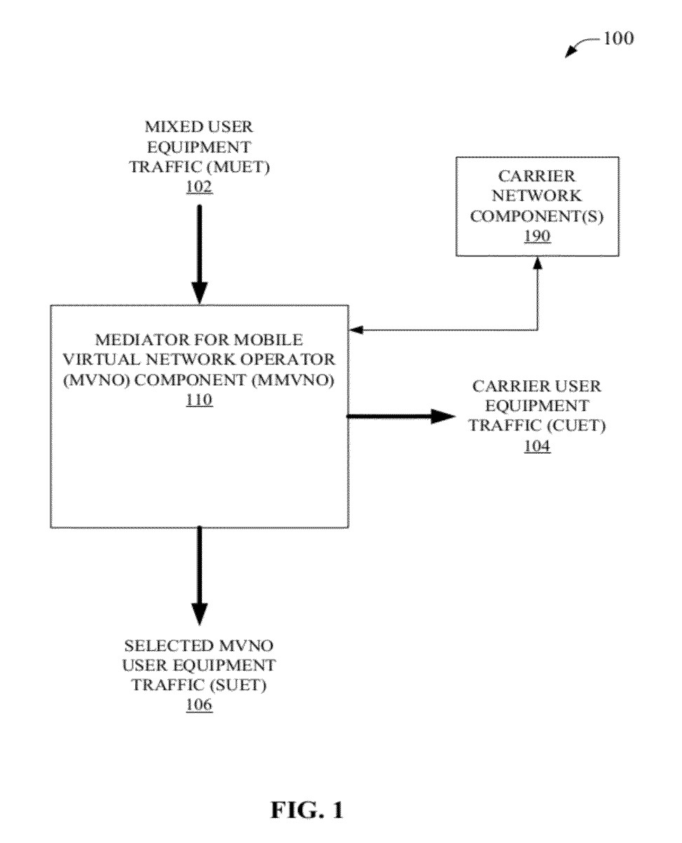

FIG. 1 is an illustration of a system 100, which facilitates mediation with a mobile virtual network operator in accordance with aspects of the subject disclosure. System 100 can include mixed user equipment traffic (MUET) 102. MUET 102 can include information from a user equipment (UE), such as telecommunications data, received at a telecommunications carrier network. As a non-limiting example, MUET 102 can include signals from a cellular phone that can be received at a NodeB or enhanced NodeB (eNodeB) and communicated through a radio area network (RAN) to a Serving General Packet Radio Service Support Node (SGSN) of a telecommunications carrier network. As a second non-limiting example, MUET 102 can include signals from a tablet computer that can be received at a femto-cell access point and communicated through a local area network (LAN) to a telecommunications carrier network. As a third non-limiting example, MUET 102 can include signals from a smartphone that can be received at a NodeB or eNodeB and communicated through a RAN to a telecommunications carrier network Mobility Management Entity (MME). MUET 102 can include voice, data, circuit switched information, packet switched information, control information, etc. Nearly any type of data associated with communication by way of a carrier network can comprise MUET 102.

System 100 can further include carrier user equipment traffic (CUET) 104. CUET 104 can be a subset of MUET 102. In some embodiments, CUET 104 can be the same as MUET 102, such as where MUET 102 only includes carrier bound traffic (e.g., CUET 104) and does not include any MVNO bound traffic (e.g., SUET 106). In other embodiments, CUET 104 can be modified MUET 102, such as a filtered subset of MUET 102. As such, CUET 104 can include voice, data, circuit switched information, packet switched information, control information, etc. Nearly any type of data associated with communication by way of a carrier network can comprise CUET 104.

System 100 can additionally include selected MVNO user equipment traffic (SUET) 106. SUET 106 can be a subset of MUET 102. In some embodiments, SUET 106 can be the same as MUET 102, such as where MUET 102 only includes MVNO bound traffic (e.g., SUET 106) and does not include any carrier bound traffic (e.g., CUET 104). In other embodiments, SUET 106 can be modified MUET 102, such as a filtered subset of MUET 102. As such, SUET 106 can include voice, data, circuit switched information, packet switched information, control information, etc. Nearly any type of data associated with communication by way of a MVNO can comprise SUET 106.

In an aspect, MUET 102 can include traffic bound for a carrier core-network, a MVNO, or a combination thereof. As such, system 100 can include mediator for MVNO component (MMVNO) 110. MMVNO 110 can inspect and route portions of MUET 102 to an appropriate destination. This inspection and route can include separation of carrier bound traffic from MUET 102 and routing of the carrier bound traffic to the carrier core-network as CUET 104. Similarly, inspection and route can include separation of MVNO bound traffic from MUET 102 and routing of the MVNO bound traffic to the MVNO interface component (not illustrated) as SUET 106. Moreover, MMVNO 110 can inspect and route to one or more subscriber MVNOs. These subscriber MVNOs can include internal and external MVNOs. As a non-limiting example, a carrier can include internal MVNOs and can employ MMVNO 110 to route traffic to those internal MVNOs. As a second non-limiting example, a government agency can operate an external MVNO and MMVNO 110 can route traffic to that external MVNO.

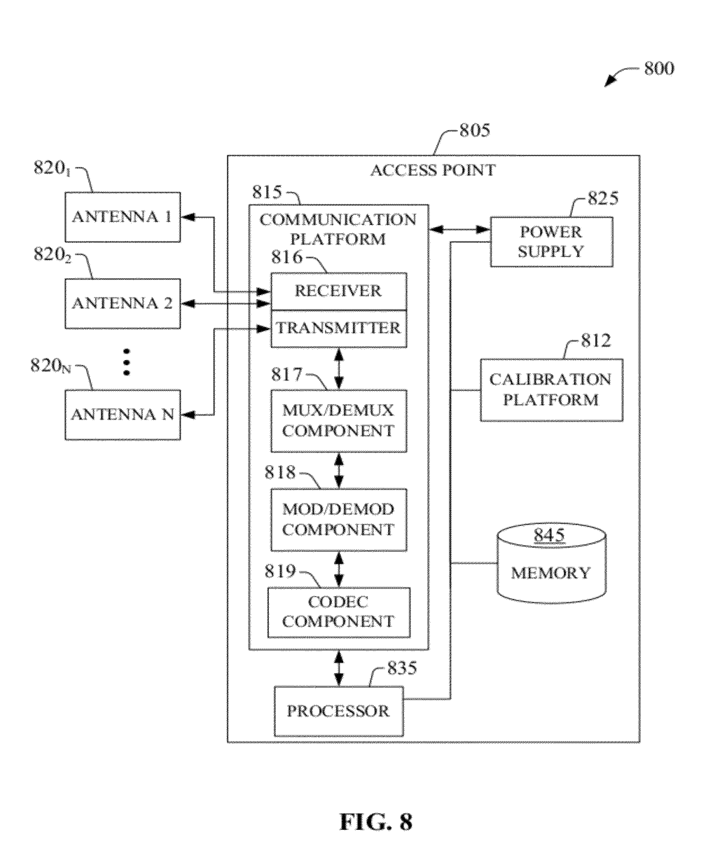

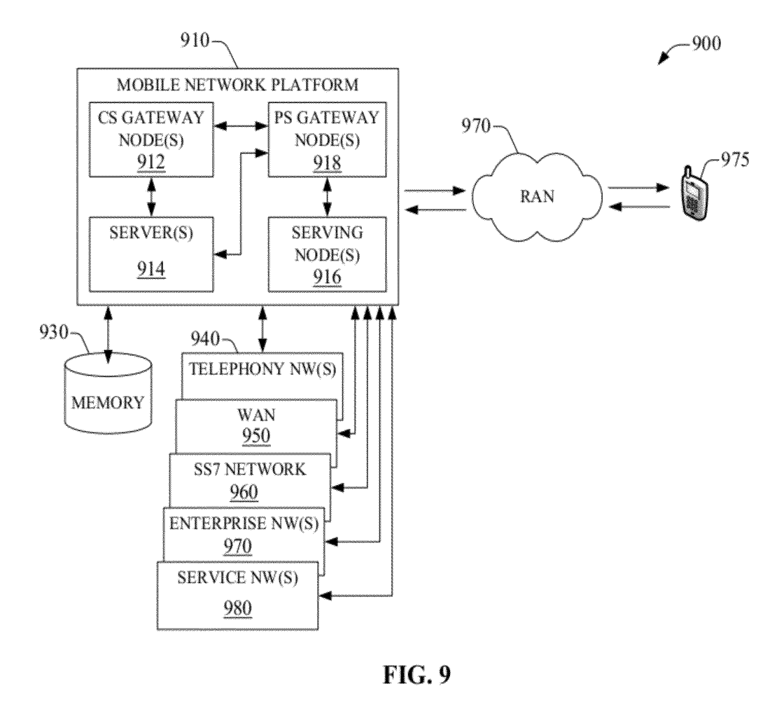

System 100 can also include carrier network component(s) 190. Carrier network component(s) 190 can include carrier core-network components. As a non-limiting example, in a General Packet Radio Service (GPRS) network, carrier network component(s) 190 can include a Serving GPRS Support Node (SGSN), a Gateway GPRS Support Node (GGSN), home location register (HLR), visitor location register (VLR), mobile switching center (MSC), etc. As a second non-limiting example, in an LTE network, carrier network component(s) 190 can include a System Architecture Evolution (SAE) gateway, Mobility Management Entity (MME), public data network (PDN) gateway, HLR, VLR, etc. Carrier network component(s) 190 can further include wireless telecommunications network components, such as, an access point (see, for example, FIG. 8) such as a femto-cell, or a radio area network (RAN) (see, for example, FIG. 9).

Further, these carrier network component(s) 190 can include virtualized core-network components. Virtualized core-network components can be virtual representations of core-network components. In some embodiments, virtual representations of core-network components can be fully virtualized, which can be complete simulations of the actual network hardware components that support unmodified network component software. In other embodiments, virtual representations of core-network components can be partially virtualized, which can include simulation of some but not all of the network hardware component environment, wherein some network component programs can need modification to run in the partially virtualized core-network environment. In still other embodiments, virtual representations of core-network components can be para-virtualized, which can include non-simulated core-network hardware environments wherein network component software can be executed in isolated domains, as if they are running on separate systems, although this software may need to be specifically modified to run in the para-virtualized environment. Virtualization of network component(s) 190 can facilitate deployment of MVNOs by reducing capitol investiture for an MVNO entity to separately deploy all or part of an MVNO core-network.

As a more detailed non-limiting example, an incoming traffic stream, MUET 102, can include both carrier bound traffic and MVNO bound traffic. MMVNO 110 can receive MUET 102. MUET 102 can be inspected by MMVNO 110 and portions of the traffic can be routed to the carrier or to the MVNO. MMVNO 110 can access a home location register (HLR) included as part of carrier network component(s) 190 to identify carrier bound traffic, such as by associating carrier bound traffic with a subscriber identity module (SIM) identifier registered with the carrier. Similarly, MMVNO 110 can access a virtual home location register (vHLR) included as part of carrier network component(s) 190 to identify MVNO bound traffic, such as by associating MVNO bound traffic with a subscriber identity module (SIM) identifier registered with the MVNO. The vHLR can, for example, be modeled on the carrier HLR but can run in a separated software environment and include HLR information for the SIMs of the MVNO. As such, MUET 102 can be separated into CUET 104 and SUET 106 by MMVNO 110 based on the HLR and vHLR information. Numerous other examples are not recited for brevity, but all such examples are to be considered within the scope of the subject disclosure. It is to be noted that MMVNO 110 can route a plurality of CUET 104 and/or SUET 106. Moreover, it is noteworthy that MMVNO 110 can receive a plurality of MUET 102 and route to one or more CUET 104 and/or SUET 106. Furthermore, it is to be noted that carrier network component(s) 190 can include a plurality of real and virtualized network components.

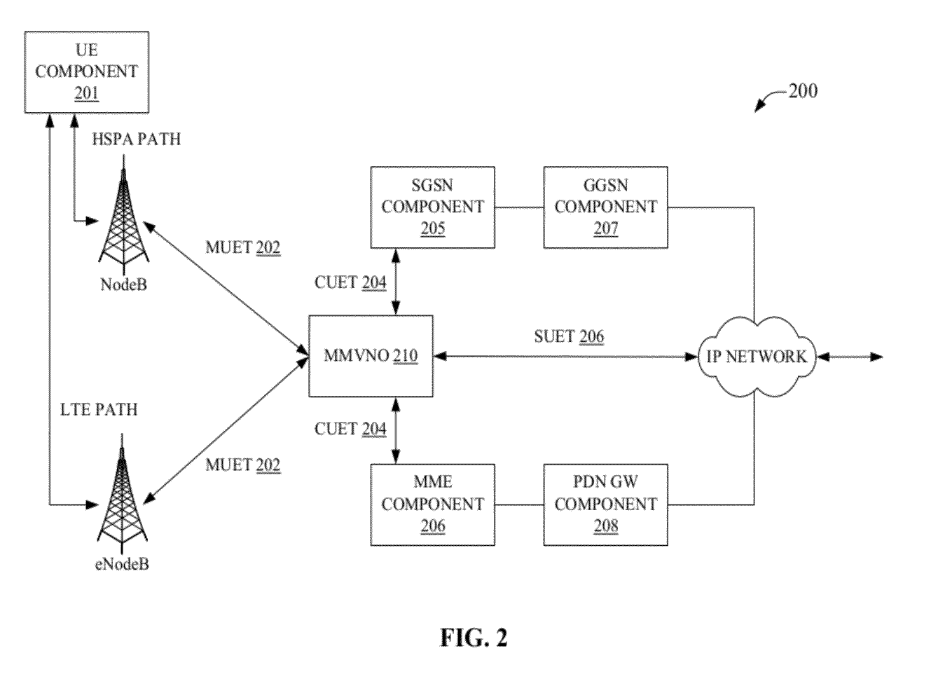

FIG. 2 is a depiction of a system 200 that can facilitate mediation for a mobile virtual network operator in accordance with aspects of the subject disclosure. System 200 can include UE component 201. UE component 201 can be any device that can seek access to a telecommunications carrier network, such as a cell phone, pager, smartphone, tablet computer, personal computer (PC), smart meter, connected appliance (e.g., internet connected refrigerator, etc.), e-reader, car computer, etc. UE 201 can be coupled to a carrier network by numerous methods including wirelessly (e.g., HSPA, LTE, etc.), personal access point (e.g., femto-cell, picocell, microcell, etc.), wired (e.g., LAN, WAN, coaxial cable, twisted pair, etc.), optically (e.g., fiber-optic cable, line of sight laser, etc.) or nearly any other means of communicative coupling. System 200 illustrates a High Speed Packet Access (HSPA) path by way of a NodeB and a Long Term Evolution (LTE) path by way of an eNodeB to the exclusion of other modalities simply for ease of explanation and clarity and the present disclosure is expressly not so limited.

System 200 can further include core carrier network components. A HSPA path can include, for example, Serving GPRS Support Node (SGSN) component 205 and Gateway GPRS Support Node (GGSN) component 207. An exemplary LTE path can include Mobility Management Entity (MME) component 206 and public data network (PDN) gateway component 208.

System 200 can include MMVNO 210 to facilitate mediation with a mobile virtual network operator. MMVNO 210 can be communicatively coupled to an IP network and, as such, can route SUET 206 to an MVNO by way of the IP network without extensive traversal of the carrier core-network. MMVNO 210 can inspect traffic flowing into the carrier network, for example from a RAN, such that, on an HSPA path, MUET 202 can be inspected before reaching SGSN component 205 and GGSN component 207. Similarly, on the LTE path, MMVNO 210 can inspect MUET 202 prior to reaching an MME component 206 and PDN gateway component 208. MUET 202 can be inspected and routed such that CUET 204 can be routed to carrier core-network components, such as SGSN component 205 or MME component 206, and MVNO traffic, e.g., SUET 206, can be routed to the MVNO by way of an IP network. Traffic passing through the GGSN component 207 or PDN gateway component 208 can then pass through the remainder of the carrier network and eventually through an IP network to a destination. It is to be noted that MMVNO 210 can be located at other points in a HSPA or LTE core carrier network, such as being part of SGSN component 205 or MME component 206, and that MUET 202 would be similarly inspected and routed from those other points.

MMVNO 210 can monitor MUET 202 near the front of the carrier core-network, e.g., as it comes from a radio network controller (RNC, not illustrated) before entering a carrier core-network component. Further, MMVNO 210 can automatically respond to observed MUET 202 conditions. As a more detailed non-limiting example, where UE 201 is a MVNO subscribed cell phone, where UE 201 sends MUET 202 that is inspected by MMVNO 210, MMVNO 210 can determine compliance with one or more traffic rules. Where the inspected MUET 202 does not comply with the traffic rules, it can be terminated. Where the inspected MUET 202 does comply with traffic rules for the MVNO, MMVNO 210 can route related traffic to the MVNO as SUET 206 by way of the IP network. This response can be automatic. Further, the response can dynamically alter the flow of the traffic based on a set of traffic rules. As non-limiting examples, MMVNO 210 can dynamically alter routing of SUET 206 based on the MVNO updating a provisioning rule; perform security procedures based on carrier rules or MVNO rules; provide access to virtualized (or real) core-components from the MMVNO 210 without needing to route all the way to the MVNO, such as to allow access to billing information; etc. Numerous other responses are not expressly disclosed for brevity, although all such responses are within the scope of the disclosed subject matter.

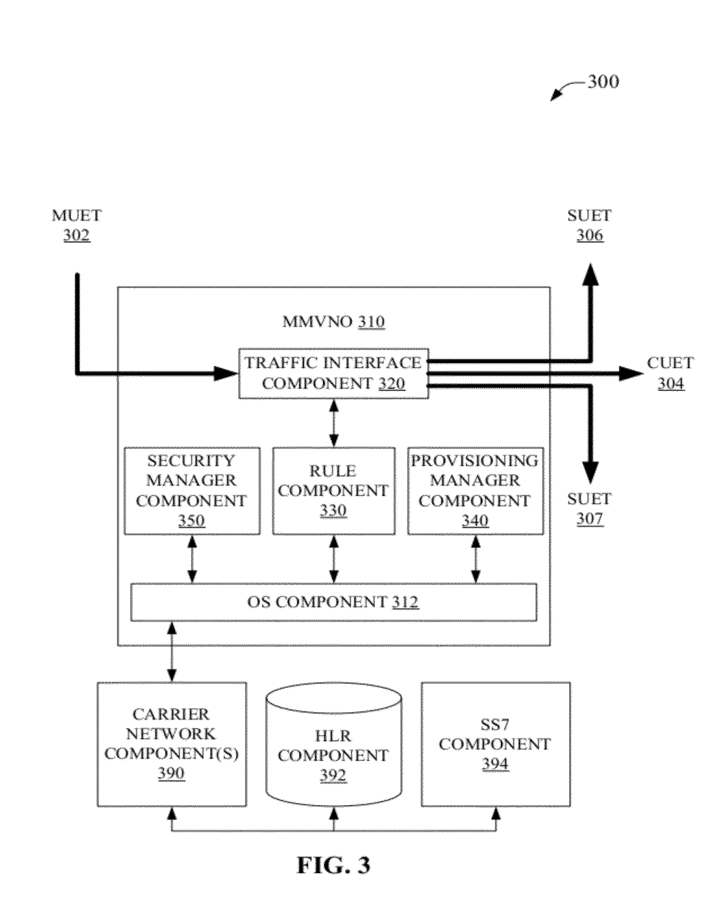

FIG. 3 illustrates a system 300 that facilitates mediation of a mobile virtual network operator in accordance with aspects of the subject disclosure. System 300 can include MUET 302. MUET 302 can be received by MMVNO 310. MMVNO 310 can inspect and route MUET 302. As an example, MUET 302 including carrier and MVNO traffic can be inspected and then traffic segments can be appropriately routed to a carrier as CUET 304, to a first MVNO as SUET 306, and to a second MVNO as SUET 307. It is to be noted that additional MVNOs and carrier networks can be targets of routed traffic.

MMVNO 310 can include traffic interface component (TIC) 330. TIC 330 can inspect MUET 302 and facilitate proper routing of traffic based on the inspection. TIC 330 can be communicatively coupled to rule component 330. Rule component 330 can apply one or more rules to the inspection of traffic at TIC 330 to determine compliance with the rule. Where MUET 302 satisfies a predetermined rule applied by rule component 330, MMVNO 310 can initiate a predetermined response. The predetermined response can include routing to a carrier network, e.g., CUET 304, routing to a MVNO, e.g., SUET 306, termination of the traffic (not illustrated), enforcement of security protocols (not illustrated), etc.

In some embodiments, MMVNO 310 can include an operating system (OS) component 312. Rule component 330 can be communicatively coupled to OS component 312. OS component 312 can further be communicatively coupled to carrier network component(s) 390. Carrier network component(s) 390 can include real and virtualized network components that can be the same as, or similar to, those disclosed elsewhere herein. In some embodiments carrier network component(s) 390 can further be communicatively coupled to HLR component 392. HLR component 392 can facilitate access to details of entities authorized to use a core-network, such as a cellular phone subscriber information, smart meter location information, parking meter identification information, etc. In other embodiments, carrier network component(s) 390 can also be communicatively coupled to signaling system #7 (SS7) component 394 to facilitate SS7 communications. Rule component 330 can receive rules, for example, by way of provisioning manager component 340 or security manager component 350.

MMVNO 310 can include provisioning manager component 340. Provisioning manager component 340 can be communicatively coupled to OS component 312 and can provision MMVNO 310. Provisioning manager component 340 can facilitate access to rules for rule component 330. Similarly, provisioning manager component 340 can facilitate access to responses for rule component 330. Further, updates to TIC component 320 can be by way of provisioning manager component 340. Moreover, provisioning manager component 340 can designate device and configuration information for one or more MMVNO 310 in a carrier network.

MMVNO 310 can also include security manager component 350. Where security manager component 350 is included, it can facilitate access to rules and responses for rule component 320. Further, security manager component 350 can manage a security catalog including alternate rules, responses, etc. In some embodiments, security manager component 350 can facilitate access to secondary security systems. These secondary security systems can facilitate access to security rules and procedures relevant to routing of traffic, such as blocking routing of SUET 307 to a MVNO where a cyber-attack on the MVNO is indicated, etc.

As depicted for system 300, carrier network component(s) 390, HLR component 392, and SS7 component 350 can be separate from MMVNO 310. As such, carrier network component(s) 390, HLR component 392, and SS7 component 350 can be local, remote, or distributed components. Further, carrier network component(s) 390, HLR component 392, and SS7 component 350 can also be part of MMVNO 310 (though not illustrated in system 300).

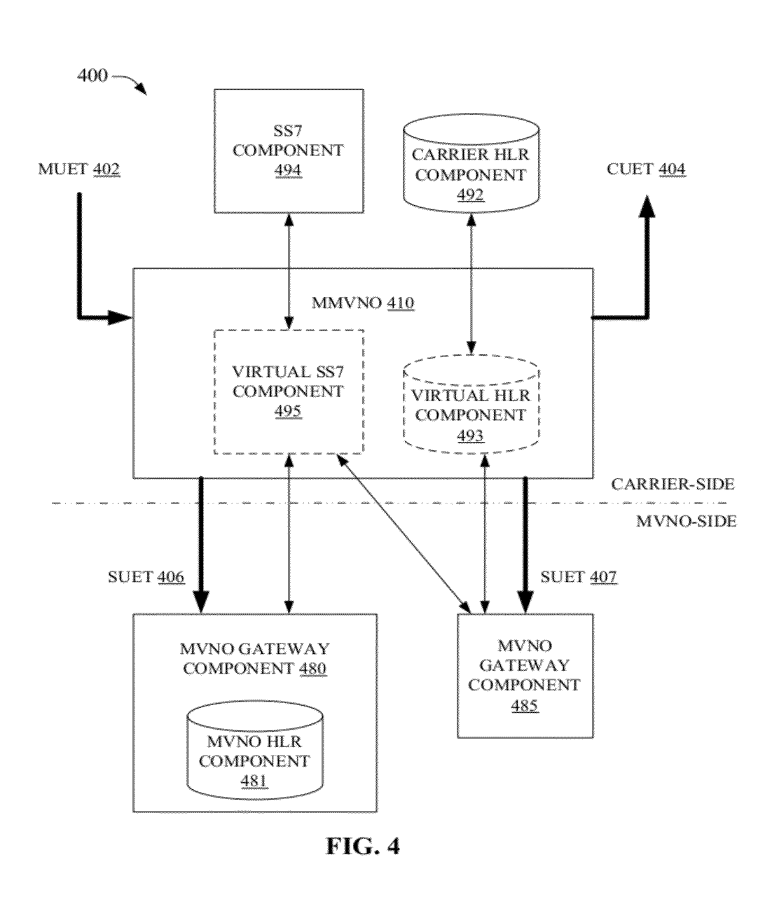

FIG. 4 is a depiction of a system 400 that facilitates mediation for a mobile virtual network operator in accordance with aspects of the subject disclosure. System 400 can include MUET 402 and CUET 404. System 400 can further include MMVNO 410, which can include TIC 430. TIC 430 can inspect MUET 402 at TIC 430. TIC 430 can be communicatively coupled to rule component (not illustrated). Rule component can apply one or more rules to the inspection of MUET 402 at TIC 430 to determine compliance with the rule. Where MUET 402 satisfies a predetermined rule applied by rule component, MMVNO 410 can initiate a predetermined response. The predetermined response can include routing carrier bound traffic as CUET 404 and MVNO bound traffic as SUET 406 and 407.

MMVNO 410 can include MVNO gateways, such as first MVNO gateway component 480 and second MVNO gateway component 485. MVNO gateways can be an IP network interface to an MVNO. As such, MVNO gateway component 480 can be an interface to a first MVNO and MVNO gateway component 485 can be an interface to a second MVNO. MMVNO 410 can make routed traffic accessible to appropriate MVNOs by way of MVNO gateways, such as SUET 406 can be made available to the first MVNO by way of MVNO gateway component 480 and SUET 407 can be made available to the second MVNO by way of MVNO gateway component 485.

In some embodiments, a MVNO can deploy a core-network, a partial core-network, or a virtualized core-network. A core-network can be a noteworthy capital investment for an MVNO, as such, partially or fully virtualized core-components can reduce the cost of entering into the MVNO market. For example, as illustrated in FIG. 4, MVNO gateway component 480 can include a real MVNO HLR component 481 but can employ a virtual SS7 component 495, e.g., the first MVNO can be viewed as having a partial core-network. Employing virtual SS7 component 495 can reduce the capital investment needed by the first MVNO to deploy. As a second example, MVNO gateway component 485 can employ virtual HLR component 493, virtual SS7 component 495, etc., and the second MVNO can be viewed as having a fully virtualized core-network.

In some embodiments, virtual core-network component, e.g., virtual HLR component 493, virtual SS7 component 495, etc., can be communicatively coupled to real core-network components, e.g., HLR component 492, SS7 component 494, etc. For example, virtual HLR component 493 can be communicatively coupled to HLR component 492 to share some or all HLR data between the real and virtual HLRs. In other embodiments, virtual core-network component, e.g., virtual HLR component 493, virtual SS7 component 495, etc., can be included in real core-network components, e.g., HLR component 492, SS7 component 494, etc. For example virtual SS7 component 495, can be part of SS7 component 494 that can be accessed by way of MMVNO 110.

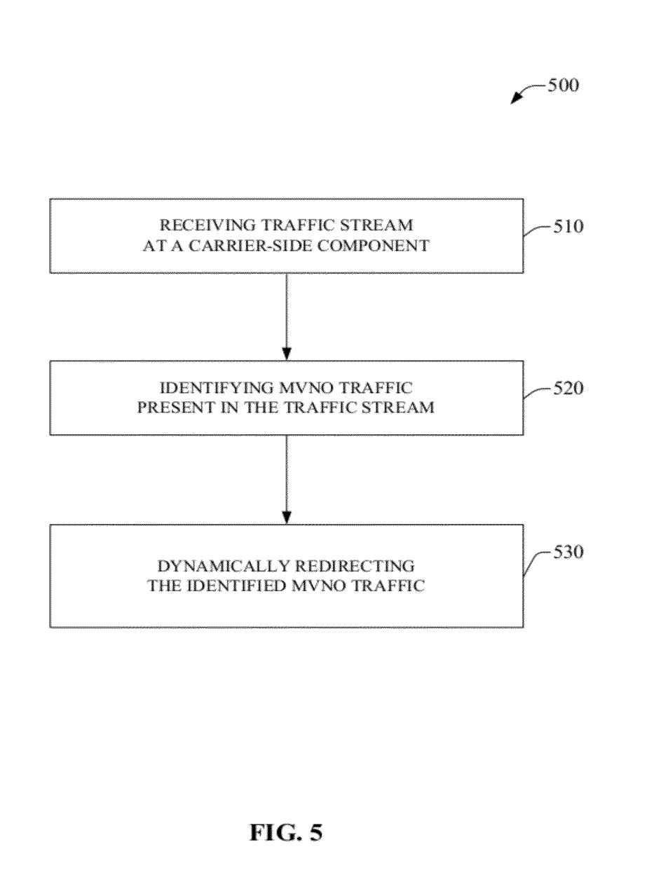

In view of the example system(s) described above, example method(s) that can be implemented in accordance with the disclosed subject matter can be better appreciated with reference to flowcharts in FIG. 5-FIG. 7. For purposes of simplicity of explanation, example methods disclosed herein are presented and described as a series of acts; however, it is to be understood and appreciated that the claimed subject matter is not limited by the order of acts, as some acts may occur in different orders and/or concurrently with other acts from that shown and described herein. For example, one or more example methods disclosed herein could alternatively be represented as a series of interrelated states or events, such as in a state diagram. Moreover, interaction diagram(s) may represent methods in accordance with the disclosed subject matter when disparate entities enact disparate portions of the methodologies. Furthermore, not all illustrated acts may be required to implement a described example method in accordance with the subject specification. Further yet, two or more of the disclosed example methods can be implemented in combination with each other, to accomplish one or more aspects herein described. It should be further appreciated that the example methods disclosed throughout the subject specification are capable of being stored on an article of manufacture (e.g., a computer-readable medium) to allow transporting and transferring such methods to computers for execution, and thus implementation, by a processor or for storage in a memory.

FIG. 5 illustrates a method 500 facilitating mediation to a mobile virtual network operator in accordance with aspects of the subject disclosure. At 510, a traffic stream can be received at a carrier-side component. The traffic stream can include mixed user equipment traffic (MUET), e.g., 102, 202, 302, 402, etc. The traffic stream can include traffic for a carrier network, a MVNO, or combinations thereof. At 520, MVNO traffic in the traffic stream can be identified. At 530, the identified MVNO traffic in the traffic stream can be dynamically redirected, such as being routed to the MVNO. At this point, method 500 can end.

In some embodiments, the carrier-side component can include a mediator for MVNO component (MMVNO), such as 110, 210, 310, 410, etc. As such, the traffic stream can be routed to a plurality of MVNO and carrier networks. Further, routing can be based on features of the traffic stream complying with one or more rules. In an aspect, the carrier-side component can dynamically adapt inspection and routing of portions of the traffic stream to a plurality of MVNOs, such as by implementing one or more rules. As such, in contrast to conventional methods, the carrier-side component can dynamically redirect traffic in accordance to provisioning, from either the carrier or a MVNO. As a non-limiting example, a new MVNO can be deployed by simply adding a rule to redirect appropriately identified traffic to the new MVNO. As a second non-limiting example, an MVNO can update the routing of traffic by updating the MVNO provisioned rules employed by the carrier-side component. Numerous other examples are not explicitly recited for brevity, but all such examples are considered within the scope of the present subject matter.

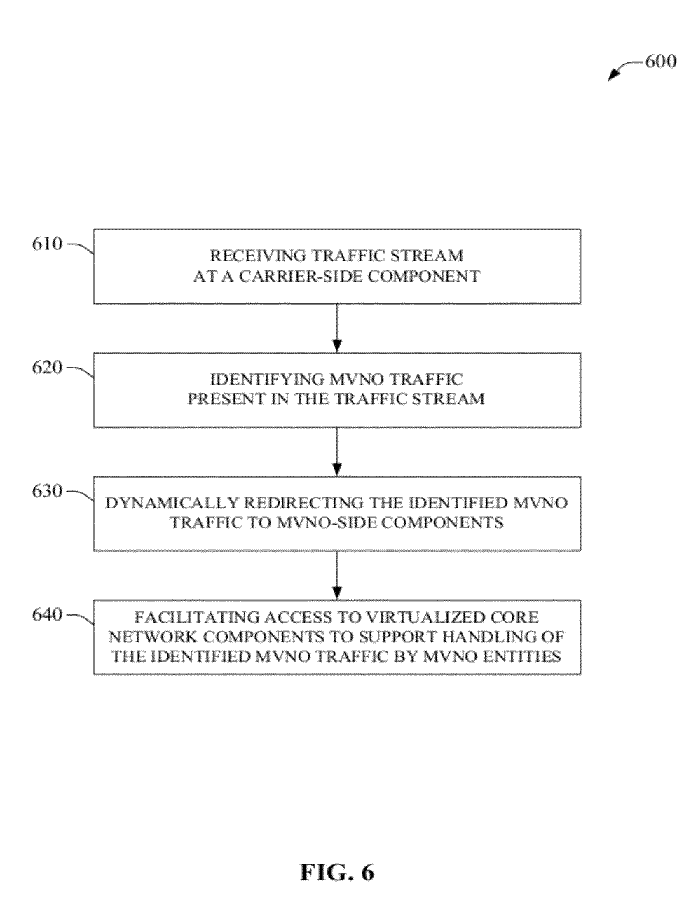

FIG. 6 illustrates aspects of a method 600 facilitating mediation of a mobile virtual network operator in accordance with aspects of the subject disclosure. At 610, a traffic stream can be received at a carrier-side component. The traffic stream can include mixed user equipment traffic (MUET), e.g., 102, 202, 302, 402, etc. The traffic stream can include traffic for a carrier network, a MVNO, or combinations thereof. At 620, MVNO traffic in the traffic stream can be identified. At 630, the identified MVNO traffic in the traffic stream can be dynamically redirected, such as being routed to the MVNO.

At 640, access to virtualized core-network components can be facilitated. This access can support the handling of the identified MVNO traffic by subscriber MVNO entities. Virtualized core-network components can be virtual representations of core-network components. In some embodiments, virtual representations of core-network components can be fully virtualized, which can be complete simulations of the actual network hardware components to allow network component software to run unmodified. In other embodiments, virtual representations of core-network components can be partially virtualized, which can include simulation of some, but not all, of the virtualized network hardware component environment, wherein some network component programs can need modification to run in the partially virtualized core-network component. In still other embodiments, virtual representations of core-network components can be para-virtualized, which can include non-simulated core-network hardware environments wherein network component software can be executed in isolated domains, as if they are running on separate systems, although these guest programs may need to be specifically modified to run in the para-virtualized environment. Virtualization of network components can facilitate deployment of MVNOs by reducing capitol investiture for an MVNO entity to separately deploy all or part of an MVNO core-network. At this point, method 500 can end.

Method 600 can provide for a carrier-side component that can facilitate deployment of MVNOs with less or no capital expenditure on core-network components. This can be in stark contrast to conventional methods that can require MVNOs to employ a complete core-network to handle redirected traffic. Method 600 can support a plurality of MVNOs and each of those MVNOs can have nearly any level of real core-network components, e.g., from a full real core-network to a completely virtual core-network. Further, method 600 facilitates MVNOs that experience changes in the MVNO core-network, such as where a MVNO experiences a failure of a SS7 component, a virtual SS7 component can be employed at the carrier-side component to minimize MVNO downtime. As a second example, where an MVNO is building out a core-network, the carrier-side component can support the MVNO at each stage of the build out, e.g., from a fully virtual core-network in the beginning to a fully real core-network at the end, and at each stage in between. Numerous other examples are not recited for brevity but are considered within the scope of the present disclosure.

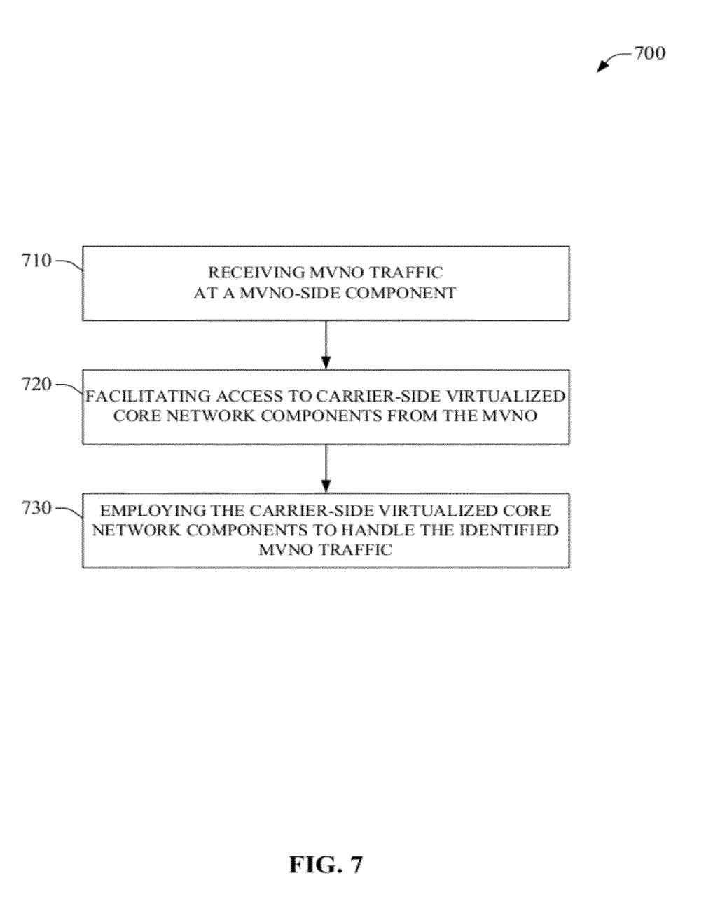

FIG. 7 illustrates a method 700 that facilitates mediation of a mobile virtual network operator in accordance with aspects of the subject disclosure. At 710, a traffic stream can be received at a MVNO-side component. The traffic stream can be routed from a carrier-side component. As a non-limiting example, an MMVNO can receive MUET and route SUET to the MVNO such that the MVNO receives the SUET at 710.

At 720, access to carrier-side virtualized core-network components can be facilitated for a MVNO. The MVNO can thus employ the carrier-side virtualized core-network components, at 730, to handle the identified MVNO traffic. As a non-limiting example, an MVNO can access a virtual HLR hosted by a carrier side component, such as a MMVNO (e.g., 493, etc.). The MVNO can then employ the virtual HLR in the handling the traffic being routed to the MVNO and received at 710. Continuing the non-limiting example, the MVNO can update the virtual HLR with new subscriber SIM information such that the traffic associated with those SIMs will be received by the MVNO-side component. At this point, method 700 can end.

FIG. 8 illustrates a block diagram of an example embodiment of an access point to implement and exploit one or more features or aspects of the subject innovation. Access point 800 can be part of a communications framework, for example, a femto-cell, a microcell, a picocell, a router, a wireless router, etc. In embodiment 800, AP 805 can receive and transmit signal(s) (e.g., attachment signaling) from and to wireless devices like femto-cell access points, access terminals, wireless ports and routers, or the like, through a set of antennas 820₁-820_{N} (N is a positive integer). It can be noted that antennas 820₁-820_{N} can be part of communication platform 815, which comprises electronic components and associated circuitry that provides for processing and manipulation of received electromagnetic signal(s) and electromagnetic signal(s) to be transmitted. Such electronic components and circuitry embody, at least in part, can comprise signaling and traffic components within a communication framework. In some embodiments, communication platform 815 can include a receiver/transmitter 816 that can convert signal from analog to digital upon reception, and from digital to analog upon transmission. In addition, receiver/transmitter 816 can divide a single data stream into multiple, parallel data streams, or perform the reciprocal operation. Coupled to receiver/transmitter 816 is a multiplexer/demultiplexer 817 that facilitates manipulation of signal in time and frequency space. Electronic component 817 can multiplex information (data/traffic and control/signaling) according to various multiplexing schemes such as time division multiplexing (TDM), frequency division multiplexing (FDM), orthogonal frequency division multiplexing (OFDM), code division multiplexing (CDM), space division multiplexing (SDM). In addition, mux/demux component 817 can scramble and spread information (e.g., codes) according to substantially any code known in the art; e.g., Hadamard-Walsh codes, Baker codes, Kasami codes, polyphase codes, and so on. A modulator/demodulator 818 is also a part of communication platform 815, and can modulate information according to multiple modulation techniques, such as frequency modulation, amplitude modulation (e.g., M-ary quadrature amplitude modulation (QAM), with M a positive integer), phase-shift keying (PSK), and the like. Communication platform 815 also includes a coder/decoder (codec) component 819 that facilitates decoding received signal(s), and coding signal(s) to convey.

Access point 805 can also include a processor 835 configured to confer functionality, at least in part, to substantially any electronic component in AP 805. Power supply 825 can attach to a power grid and include one or more transformers to achieve a power level that can operate AP 805 components and circuitry. Additionally, power supply 825 can include a rechargeable power component to ensure operation when AP 805 is disconnected from the power grid, or in instances, the power grid is not operating.

Processor 835 also is functionally connected to communication platform 815 and can facilitate operations on data (e.g., symbols, bits, or chips) for multiplexing/demultiplexing, such as effecting direct and inverse fast Fourier transforms, selection of modulation rates, selection of data packet formats, inter-packet times, etc. Moreover, processor 835 is functionally connected, via a data or system bus, to calibration platform 812 and other components (not shown) to confer, at least in part functionality to each of such components.

In AP 805, memory 845 can store data structures, code instructions and program modules, system or device information, code sequences for scrambling, spreading and pilot transmission, location intelligence storage, determined delay offset(s), over-the-air propagation models, and so on. Processor 835 is coupled to the memory 845 in order to store and retrieve information necessary to operate and/or confer functionality to communication platform 815, calibration platform 812, and other components (not shown) of access point 805.

FIG. 9 presents an example embodiment 900 of a mobile network platform 910 that can implement and exploit one or more aspects of the subject innovation described herein. Generally, wireless network platform 910 can include components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, wireless network platform 910 can be included in telecommunications carrier networks, such as those illustrated in part in FIG. 2 and discussed elsewhere herein. Mobile network platform 910 includes CS gateway node(s) 912 which can interface CS traffic received from legacy networks like telephony network(s) 940 (e.g., public switched telephone network (PSTN), or public land mobile network (PLMN)) or a signaling system #7 (SS7) network 970. Circuit switched gateway node(s) 912 can authorize and authenticate traffic (e.g., voice) arising from such networks. Additionally, CS gateway node(s) 912 can access mobility, or roaming, data generated through SS7 network 970; for instance, mobility data stored in a visited location register (VLR), which can reside in memory 930. Moreover, CS gateway node(s) 912 interfaces CS-based traffic and signaling and PS gateway node(s) 918. As an example, in a 3GPP UMTS network, CS gateway node(s) 912 can be realized at least in part in gateway GPRS support node(s) (GGSN). It should be appreciated that functionality and specific operation of CS gateway node(s) 912, PS gateway node(s) 918, and serving node(s) 916, is provided and dictated by radio technology(ies) utilized by mobile network platform 910 for telecommunication.

In addition to receiving and processing CS-switched traffic and signaling, PS gateway node(s) 918 can authorize and authenticate PS-based data sessions with served mobile devices. Data sessions can include traffic, or content(s), exchanged with networks external to the wireless network platform 910, like wide area network(s) (WANs) 950, enterprise network(s) 970, and service network(s) 980, which can be embodied in local area network(s) (LANs), can also be interfaced with mobile network platform 910 through PS gateway node(s) 918. It is to be noted that WANs 950 and enterprise network(s) 960 can embody, at least in part, a service network(s) like IP multimedia subsystem (IMS). Based on radio technology layer(s) available in technology resource(s) 917, packet-switched gateway node(s) 918 can generate packet data protocol contexts when a data session is established; other data structures that facilitate routing of packetized data also can be generated. To that end, in an aspect, PS gateway node(s) 918 can include a tunnel interface (e.g., tunnel termination gateway (TTG) in 3GPP UMTS network(s) (not shown)) which can facilitate packetized communication with disparate wireless network(s), such as Wi-Fi networks.

In embodiment 900, wireless network platform 910 also includes serving node(s) 916 that, based upon available radio technology layer(s) within technology resource(s) 917, convey the various packetized flows of data streams received through PS gateway node(s) 918. It is to be noted that for technology resource(s) 917 that rely primarily on CS communication, server node(s) can deliver traffic without reliance on PS gateway node(s) 918; for example, server node(s) can embody at least in part a mobile switching center. As an example, in a 3GPP UMTS network, serving node(s) 916 can be embodied in serving GPRS support node(s) (SGSN).

For radio technologies that exploit packetized communication, server(s) 914 in wireless network platform 910 can execute numerous applications that can generate multiple disparate packetized data streams or flows, and manage (e.g., schedule, queue, format . . . ) such flows. Such application(s) can include add-on features to standard services (for example, provisioning, billing, customer support . . . ) provided by wireless network platform 910. Data streams (e.g., content(s) that are part of a voice call or data session) can be conveyed to PS gateway node(s) 918 for authorization/authentication and initiation of a data session, and to serving node(s) 916 for communication thereafter. In addition to application server, server(s) 914 can include utility server(s), a utility server can include a provisioning server, an operations and maintenance server, a security server that can implement at least in part a certificate authority and firewalls as well as other security mechanisms, and the like. In an aspect, security server(s) secure communication served through wireless network platform 910 to ensure network's operation and data integrity in addition to authorization and authentication procedures that CS gateway node(s) 912 and PS gateway node(s) 918 can enact. Moreover, provisioning server(s) can provision services from external network(s) like networks operated by a disparate service provider; for instance, WAN 950 or Global Positioning System (GPS) network(s) (not shown). Provisioning server(s) can also provision coverage through networks associated to wireless network platform 910 (e.g., deployed and operated by the same service provider), such as femto-cell network(s) (not shown) that enhance wireless service coverage within indoor confined spaces and offload RAN resources in order to enhance subscriber service experience within a home or business environment.

It is to be noted that server(s) 914 can include one or more processors configured to confer at least in part the functionality of macro network platform 910. To that end, the one or more processor can execute code instructions stored in memory 930, for example. It is should be appreciated that server(s) 914 can include a content manager 915, which operates in substantially the same manner as described hereinbefore.

In example embodiment 900, memory 930 can store information related to operation of wireless network platform 910. Other operational information can include provisioning information of mobile devices served through wireless platform network 910, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 930 can also store information from at least one of telephony network(s) 940, WAN 950, enterprise network(s) 960, or SS7 network 970. In an aspect, memory 930 can be, for example, accessed as part of a data store component or as a remotely connected memory store.

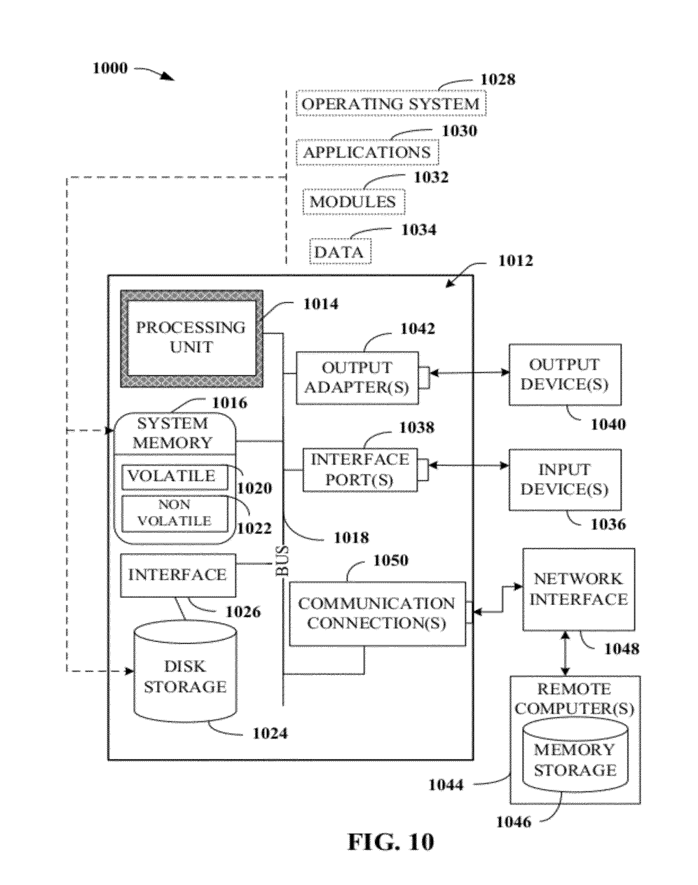

In order to provide a context for the various aspects of the disclosed subject matter, FIG. 10, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the subject innovation also can be implemented in combination with other program modules. Generally, program modules include routines, programs, components, data structures, etc. that perform particular tasks and/or implement particular abstract data types.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory.

By way of illustration, and not limitation, nonvolatile memory, for example, can be included in MMVNO 110-410, rule component 320 to store MMVNO rules and/or responses, volatile memory 1020, non-volatile memory 1022 (see below), disk storage 1024 (see below), and memory storage 1046 (see below). Further, nonvolatile memory can be included in read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, including single-processor or multiprocessor computer systems, mini-computing devices, mainframe computers, as well as personal computers, hand-held computing devices (e.g., PDA, phone, watch, tablet computers, . . . ), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

FIG. 10 illustrates a block diagram of a computing system 1000 operable to execute the disclosed systems and methods in accordance with an embodiment. Computer 1012 (which can be, for example, part of the hardware of a MMVNO (e.g., 110-410, etc.), a femto-cell (e.g., access point), etc., includes a processing unit 1014, a system memory 1016, and a system bus 1018. System bus 1018 couples system components including, but not limited to, system memory 1016 to processing unit 1014. Processing unit 1014 can be any of various available processors. Dual microprocessors and other multiprocessor architectures also can be employed as processing unit 1014.

System bus 1018 can be any of several types of bus structure(s) including a memory bus or a memory controller, a peripheral bus or an external bus, and/or a local bus using any variety of available bus architectures including, but not limited to, Industrial Standard Architecture (ISA), Micro-Channel Architecture (MSA), Extended ISA (EISA), Intelligent Drive Electronics, VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1194), and Small Computer Systems Interface (SCSI).

System memory 1016 includes volatile memory 1020 and nonvolatile memory 1022. A basic input/output system (BIOS), containing routines to transfer information between elements within computer 1012, such as during start-up, can be stored in nonvolatile memory 1022. By way of illustration, and not limitation, nonvolatile memory 1022 can include ROM, PROM, EPROM, EEPROM, or flash memory. Volatile memory 1020 includes RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 also includes removable/non-removable, volatile/non-volatile computer storage media. FIG. 10 illustrates, for example, disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to system bus 1018, a removable or non-removable interface is typically used, such as interface 1026.

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

It can be noted that FIG. 10 describes software that acts as an intermediary between users and computer resources described in suitable operating environment 1000. Such software includes an operating system 1028 (e.g., OS component(s) 312, etc.) Operating system 1028, which can be stored on disk storage 1024, acts to control and allocate resources of computer system 1012. System applications 1030 take advantage of the management of resources by operating system 1028 through program modules 1032 and program data 1034 stored either in system memory 1016 or on disk storage 1024. It is to be noted that the disclosed subject matter can be implemented with various operating systems or combinations of operating systems.

A user can enter commands or information into computer 1011 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, cell phone, smartphone, tablet computer, etc. These and other input devices connect to processing unit 1014 through system bus 1018 by way of interface port(s) 1038. Interface port(s) 1038 include, for example, a serial port, a parallel port, a game port, a universal serial bus (USB), an infrared port, a Bluetooth port, an IP port, or a logical port associated with a wireless service, etc. Output device(s) 1040 use some of the same type of ports as input device(s) 1036.

Thus, for example, a USB port can be used to provide input to computer 1012 and to output information from computer 1012 to an output device 1040. Output adapter 1042 is provided to illustrate that there are some output devices 1040 like monitors, speakers, and printers, among other output devices 1040, which use special adapters. Output adapters 1042 include, by way of illustration and not limitation, video and sound cards that provide means of connection between output device 1040 and system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. Remote computer(s) 1044 can be a personal computer, a server, a router, a network PC, a workstation, a microprocessor based appliance, a peer device, or other common network node and the like, and typically includes many or all of the elements described relative to computer 1012.

For purposes of brevity, only a memory storage device 1046 is illustrated with remote computer(s) 1044. Remote computer(s) 1044 is logically connected to computer 1012 through a network interface 1048 and then physically connected by way of communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). As noted below, wireless technologies may be used in addition to or in place of the foregoing.

Communication connection(s) 1050 refer(s) to hardware/software employed to connect network interface 1048 to bus 1018. While communication connection 1050 is shown for illustrative clarity inside computer 1012, it can also be external to computer 1012. The hardware/software for connection to network interface 1048 can include, for example, internal and external technologies such as modems, including regular telephone grade modems, cable modems and DSL modems, ISDN adapters, and Ethernet cards.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point (AP),” “base station,” “Node B,” “evolved Node B (eNode B),” “home Node B (HNB),” “home access point (HAP),” and the like, are utilized interchangeably in the subject application, and refer to a wireless network component or appliance that serves and receives data, control, voice, video, sound, gaming, or substantially any data-stream or signaling-stream to and from a set of subscriber stations or provider enabled devices. Data and signaling streams can include packetized or frame-based flows.

Additionally, the term “core-network”, “core”, “core carrier network”, or similar terms can refer to components of a telecommunications network that typically providing some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. UEs do not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g. call transfer) or implicitly (e.g., call waiting). It is to be noted that service “execution” may or may not be a core network functionality as third party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) Radio Access Network (RAN) or GERAN; UMTS Terrestrial Radio Access Network (UTRAN); or LTE Advanced.

What has been described above includes examples of systems and methods illustrative of the disclosed subject matter. It is, of course, not possible to describe every combination of components or methodologies here. One of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A system, comprising:
a carrier-side mediator component configured to automatically facilitate dynamic routing of a portion of a traffic stream in response to a presence of a portion of a mobile virtual network operator traffic stream in the traffic stream; and
a carrier network component of a carrier network, communicatively coupled to the carrier-side mediator component, configured to facilitate access to a network gateway component of a mobile virtual network operator.

2. The system of claim 1, wherein the portion of the traffic stream includes the portion of the mobile virtual network operator traffic stream.

3. The system of claim 2, wherein the carrier-side mediator component is further configured to facilitate routing the portion of the mobile virtual network operator traffic stream to a mobile virtual network operator.

4. The system of claim 1, wherein the carrier-side mediator component is configured to act as a front end mediator for the carrier network component.

5. The system of claim 4, wherein the carrier network component is at a front end of the carrier network and the traffic stream passes through the carrier-side mediator component before being routed through another carrier network component of the carrier network.

6. The system of claim 1, wherein the carrier network component is further configured to facilitate access to a virtual network component.

7. The system of claim 6, wherein the virtual network component is a substitute for a network component of a mobile virtual network operator.

8. The system of claim 6, wherein the virtual network component is a substitute for a core network of a mobile virtual network operator.

9. The system of claim 1, further comprising a provisioning component configured to facilitate provisioning of the carrier-side mediator component by a carrier.

10. The system of claim 1, further comprising a provisioning component configured to facilitate provisioning of the carrier-side mediator component by a mobile virtual network operator.

11. The system of claim 1, further comprising:
a traffic interface component configured to receive the traffic stream; and
a rule component, communicatively coupled to the traffic interface component, configured to cause an inspection of the traffic stream.

12. The system of claim 11, wherein the rule component is further configured to apply a predetermined rule to the inspection of the traffic stream.

13. A method, comprising:
receiving, by a carrier-side computing device, a traffic stream;
determining a condition of the traffic stream indicative of routing the traffic stream to a mobile virtual network operator; and
dynamically adapting the traffic stream in response to the determining the condition.

14. The method of claim 13, further comprising facilitating access to a virtual network component to support handling of the traffic stream.

15. The method of claim 14, wherein the virtual network component is a substitute for a network component of a mobile virtual network operator.

16. The method of claim 14, wherein the virtual network component is a substitute for a core network of a mobile virtual network operator.

17. The method of claim 13, wherein the determining the condition is based on the traffic stream satisfying a condition of a predetermined rule, the predetermined rule being subject to dynamic update by a mobile virtual network operator.

18. A computing device, comprising:
a processor located at a mobile virtual network operator, the processor configured to support mobile virtual network operator traffic; and
a mobile virtual network operator gateway component configured to receive a subset of a traffic stream, the subset of the traffic stream being dynamically selected from a superset of the traffic stream by a carrier-side mediator component based on a feature of the traffic stream satisfying a condition of a predetermined rule.

19. The computing device of claim 18, wherein the predetermined rule is updated by a mobile virtual network operator associated with the mobile virtual network operator computing device.

20. The computing device of claim 18, wherein a mobile virtual network operator associated with the mobile virtual network operator computing device employs a carrier-side network component as a substitute for a mobile virtual network operator-side network component.
